(19) United States
(12) Patent Application Publication
(10) Pub. No.: US 2013/0149656 A1
(43) Pub. Date: Jun. 13, 2013

(54) FLUIDISED BED TREATMENT

(71) Applicant: Rolls-Royce Plc, London (GB)

(72) Inventors: Bhrami JEGATHEESWARAM PILLAI, Derby (GB); Paul Anthony GOULDING, Derby (GB); Daniel Jason HOWE, Hereford (GB); Kin Keung CHAN, Dudley (GB)

(73) Assignee: ROLLS-ROYCE PLC, London (GB)

(21) Appl. No.: 13/683,458

(22) Filed: Nov. 21, 2012

(30) Foreign Application Priority Data
Dec. 13, 2011 (GB) 1121353.5

(51) Int. Cl. F27B 15/00

(52) U.S. Cl. CPC F27B 15/00
USPC 432/27; 432/58

(57) ABSTRACT

An apparatus and process is disclosed for the treatment of a component using a fluidised bed of powder. The apparatus includes a treatment chamber for receiving at least a treatment part of the component and a powder reservoir. The powder reservoir has heating or cooling means for controlling the temperature of the powder. A flexible powder conveyor (e.g. educator) links the treatment chamber and the powder reservoir, continuously conveying powder from the reservoir to the treatment chamber for use in the fluidised bed. The powder reservoir and the treatment chamber are independently positionable, so that the position of the treatment chamber is variable with respect to the powder reservoir during operation of the apparatus.

### FIELD OF THE INVENTION

The present invention relates to methods of treatment of components using fluidised beds and to apparatus for carrying out such methods. The invention has particular, but not exclusive, application to the thermal treatment of components, such as metallic components. Suitable thermal treatments typically include heat treatment but may also include cooling treatment. Suitable thermal treatments may be applied to a component in order to promote stress relief and/or the development of a preferred microstructure, for example, in order to obtain desired mechanical properties. The invention has particular applicability to the treatment of turbomachinery blades, but the invention is not necessarily limited to the treatment of such components.

### BACKGROUND OF THE INVENTION

A fluidised bed typically consists of a bed of solid particles in the form of a powder (referred to as “media” or “solid media”) situated on a distributor plate located above a plenum chamber. The distributor plate has an arrangement of many gas flow passages through it. Introduction of a process gas into the plenum chamber creates a pressure drop across the distributor plate. The resultant flow of process gas into the bed of media causes fluidisation. The result is a heterogeneous mixture of the process gas and solid particles that behaves macroscopically as a fluid.

Fluidised beds typically provide a very high surface area contact between the fluidising gas and the solid media, compared with the contact area available for a packed solid bed. Fluidised beds also provide very good thermal transfer between the walls of the fluidised bed apparatus, the fluidising gas, the media and any component located in the media. This is due to the high surface area contact between the fluidising gas and the solid media and due to the very frequent particle-particle, particle-wall and particle-component collisions.

Fluidised bed apparatus typically have rectangular or cylindrical configurations.

It is known to use fluidised beds in order to provide a controlled heat treatment for components, for example in order to provide a hardness gradient within the component. Some example disclosures are discussed below.

U.S. Pat. No. 3,519,497 discloses a method of controlling the cooling of a rail section. The rail section is subjected to hot rolling and is immediately submerged in a fluidised bed. The fluidised bed is maintained at a predetermined temperature, in order to provide isothermal conditions for a bainitic microstructural transformation. The rail section is held in the fluidised bed in a particular orientation in order to provide stagnant regions of the flow in the fluidised bed. In turn, this affects the rate of cooling to which different parts of the rail section are subjected, and so affects the hardness/metallurgical properties throughout the rail section.

DE-C-3429707 discloses a method of locally hardening drill bits. A cartridge is loaded with drill bits. The cartridge is submerged into a fluidised bed. The cartridge holds the drill bits in such a way that, for each drill bit, only the surface to be treated is exposed whilst the remainder is shielded with insulation. This allows a custom boundary/interface to be achieved for varying component geometries.

In the two documents discussed above, the entire component is submerged in the fluidised bed, but special measures are taken in order to achieve differential heat treatment of different parts of the component.

Other documents disclose the submersion of only a part of the component to be treated, in order to ensure that only the submerged part is subjected to the required heat treatment. The intention here is also to provide a localised heat treatment in order to produce a controlled and sustained thermal gradient within and across the component.

For example, JP-A-2005-059054 discloses the use of a fluidised bed to create a high temperature gradient within a component. The component is partially dipped in at the top of the bed for localised heat treatment to induce a temperature gradient. FIGS. 2, 3 and 4 of JP-A-2005-059054 show how the component is suspended above the top of the bed and the part of the component to be treated is lowered into the bed.

JP-A-2003-013142 discloses heat treatment of a pipe section. The pipe section has a major portion formed with a constant, relatively small, wall thickness. A connection portion at the end of the pipe section, however, has a greater wall thickness. In order to apply the same heat treatment to the different parts of the pipe section, when taking into account the different wall thickness, the connection portion of the pipe is dipped into a fluidised bed, in order to provide a heat treatment specific to that part of the pipe section. The entire pipe section is held in a furnace in order to provide a heat treatment specific to the major portion of the pipe section.

### SUMMARY OF THE INVENTION

The present inventors have realised that there are drawbacks with the methods and apparatus discussed above, when the aim is to provide local heat treatment of only part of a component, or where the component to be treated is difficult to access.

U.S. Pat. No. 3,519,497, for example, discloses heat treatment of rail sections, in the sense of controlling the temperature of the rail section whether by inputting heat into the fluidised bed using heating means or by extracting heat from the fluidised bed using cooling means. The heating means and cooling means disclosed in U.S. Pat. No. 3,519,497 operate directly to heat or cool the solid particles of the media when in the fluidised bed. As will be understood, given that the purpose of the fluidised bed in US-A-3,519,497 is to heat treat rail sections, the fluidised bed must be very large in order to completely submerge the entire rail section.

The present invention is based on the realisation by the present inventors that it would be advantageous to be able to carry out treatment on components that may be relatively difficult to treat by immersion in a known fluidised bed. Such components may be large, attached to other components, and/or it may be wanted to carry out the treatment on only a treatment part of the component. In such a case, the present inventors realise that it may be more convenient to present the fluidised bed to the component, rather than to present the component to the fluidised bed. However, where the treatment to be carried out is thermal treatment, there is the problem of how the temperature of the media of the fluidised bed should be controlled, since suitable heaters and coolers of a power typical for use in fluidised beds, can be heavy and/or bulky.

The present invention has been devised in order to address at least one (and preferably all) of the problems mentioned above. In preferred embodiments, the present invention reduces, ameliorates, avoids or even overcomes one or more of these problems.

In a first preferred aspect, the present invention provides an apparatus for the treatment of a component using a fluidised bed of powder, the apparatus including:

a treatment chamber for receiving at least a treatment part of the component;
a powder reservoir having heating or cooling means for controlling the temperature of the powder; and
a powder conveying means linking the treatment chamber and the powder reservoir, for continuously conveying powder from the reservoir to the treatment chamber for use in the fluidised bed,
wherein the position of the treatment chamber is variable with respect to the powder reservoir during operation of the apparatus.

In a second preferred aspect, the present invention provides a process for the treatment of a component using a fluidised bed of powder, wherein the fluidised bed is formed in a treatment chamber and in contact with at least a treatment part of the component, and wherein the powder is subjected to heating or cooling in a powder reservoir located away from the treatment chamber, the position of the treatment chamber being variable with respect to the powder reservoir during the process, the powder being continuously conveyed to the treatment chamber from the powder reservoir by a powder conveyor.

In a third preferred aspect, the present invention provides a kit of parts suitable for assembling an apparatus according to the first aspect, wherein the kit includes two or more interchangeable treatment chambers of different shape, in order to adapt the apparatus to different shapes of specific components to be treated.

The first, second and/or third aspect of the invention may have any one or, to the extent that they are compatible, any combination of the following optional features.

Using the invention, it is therefore possible to provide heat treatment of a component or a part of a component that is large or difficult to reach, by bringing the treatment chamber to the component. Allowing the temperature of the powder to be controlled remotely from the treatment chamber allows the treatment chamber itself to be made more easy to manipulate and locate in a required location. The invention also allows further treatments to be applied to the component, e.g. chemical treatments.

In the powder reservoir, the powder can be in fluidised or non-fluidised form. Preferably, the powder is in non-fluidised form, and thus for a given volume, the reservoir can hold a greater mass of powder. Where the powder is in non-fluidised form, the reservoir may still include one or more mixing elements, in order to reduce temperature variations through the powder.

The heating/cooling means may be any suitable means of sufficient power to provide the required powder temperature.

The powder conveying means can be a conveyor belt (or arrangement of conveyor belts), a screw feed or a gravity feed. Alternatively, the powder conveying means can be provided by a fluid flow, such as a gas stream. A gas eductor can provide a suitable powder conveying means. In general, the powder conveying means should be closed to air.

Preferably, the powder conveying means is flexible. This helps to position the treatment chamber with respect to the component to be treated, without necessarily needing to reposition the powder reservoir. Similarly, the powder conveying means may be extendable, e.g. telescopic.

There may be provided a return powder conveying means linking the treatment chamber and the powder reservoir. Preferably, the return powder conveying means transports powder from the fluidised bed back to the powder reservoir. Powder is required to be removed from the fluidised bed when its temperature is no longer suitable for the required thermal treatment of the component. However, such powder is then typically not at ambient temperature, but instead is at a temperature intermediate that of the powder in the powder reservoir and ambient. Thus, to increase the thermal efficiency of the apparatus, the powder is returned to the powder reservoir for renewed heating/cooling before being conveyed once more to the treatment chamber. This not only reduces the heating/cooling load on the heating/cooling means, but also reduces the volume of powder required to be held by the powder reservoir and thus further improves the flexibility and portability of the apparatus.

The treatment chamber typically requires a fluidising gas flow in order to fluidise the powder in the treatment chamber. Where the powder is conveyed to the treatment chamber by mechanical means, there may be provided a separate fluidising gas flow to the treatment chamber. However, where the powder is transported to the treatment chamber by entrainment in a gas flow, the same gas flow can be used in the treatment chamber to generate the required fluidised bed.

The treatment chamber may include more than one fluidising gas inlet. Multiple inlets may be preferred in particular in order to establish a desired powder flow distribution within the treatment chamber. For example, it may be required to have different parts of the component subjected to incoming powder at different angles. This can help to ensure that the required heat treatment is given to the treatment part of the component in the treatment chamber.

The fluidising gas can be air. However, for some thermal treatments of some components, it may be preferred that the fluidising gas is not air. For example, an inert gas may be preferred, e.g. nitrogen or argon. In some embodiments, it is preferred to recycle the fluidising gas. This allows heat recovery from the fluidising gas, and also reduces the cost of operating the apparatus.

Fluidisation of the bed can be achieved by methods other than a flow of gas. For example, vibration, or a combination of gas and vibration.

The apparatus may include more than one treatment chamber. Each treatment chamber may be used to treat a different treatment part of the same or different components. This allows the same powder reservoir to be used to treat the different treatment parts simultaneously, giving rise to efficient operation of the apparatus.

The treatment chamber has an internal volume suitable for holding the fluidised bed. The powder reservoir has an internal reservoir suitable for holding the powder. Preferably the internal volume of the powder reservoir is at least 5 times greater than the internal volume of the treatment chamber.

As mentioned earlier, the powder in the treatment chamber is fluidised but the powder in the powder reservoir is typically not fluidised. Therefore it is possible that the density of the powder in the treatment chamber is far lower than the density of the powder in the powder reservoir. It is therefore preferred that the mass of powder in the powder reservoir during operation of the apparatus is at least 5 times greater than the mass of powder in the treatment chamber.

Preferably, the powder conveying means is of a length suitable to the required distance between the powder reservoir and the treatment chamber(s) and the component(s) to be treated. For example, the powder conveying means may be at least 1 m long. The component may be located in the treatment chamber from the top of the treatment chamber, with the treatment part of the component defined by that part of the component which is submerged under the surface of the fluidised bed. However, partially submerging a component in the fluidised media can lead to poor repeatability of the heat treatment process. This is because the surface of the fluidised media is not perfectly level but instead the local height of the surface fluctuates randomly, due to bubbling. Thus there is the problem that it can be very difficult to obtain an even exposure level of the chosen part of the component for heat treatment.

The restrictions of gravity mean that the surface of the fluidised media (ignoring the local random fluctuations mentioned above) is horizontal. This affects the parts of the component that can be treated. Typically, if it is wanted to subject more than one part of the component to the same heat treatment at the same time, these parts of the component must be located on the component in such a disposition as to allow simultaneous submersion of these parts in the fluidised media.

With respect to U.S. Pat. No. 3,519,497, this document discloses submerging the entire component into the fluidised bed and yet still obtaining different rates of cooling at different parts of the component. However, the disclosure of U.S. Pat. No. 3,519,497 is still effectively a ‘global’ heat transfer process, and it would be difficult to modify that disclosure in order to achieve a highly localised application of heat treatment to a component. In contrast, preferred embodiments of the present invention allow different parts of the same component to be subjected to localised cooling and localised heating.

With respect to DE-C-3429707, it is considered likely that the insulated parts of the components submerged into the fluidised media would still be subjected to unwanted heat treatment. Still further, it is considered that it would be difficult to apply the teaching of DE-C-3429707 to large components, because this would involve manufacturing a large container that could encapsulate and protect sections of the component that should be protected from the heat treatment.

The present inventors have considered the situation in which part of a component is submerged under the surface of a fluidised bed, leaving the remainder of the component projecting from the surface of the fluidised bed. The inventors have realised that the boundary between the part of the component to be treated and the remainder of the component is constrained by the global horizontal arrangement of the surface of the fluidised bed and the locally random irregularly fluctuating shape of the surface of the fluidised bed. Instead of this, the inventors propose that the boundary between the part of the component to be treated and the reminder of the component should be defined by a boundary containment surface of the fluidised bed. Such a surface can be located with precision, and need not be horizontal, or planar. This allows the repeatability of the treatment to be improved, and also improves the flexibility of the process, in terms of treating different parts of different components.

Considering that the fluidised bed is retained in the treatment chamber by one or more containment surfaces, at least one treatment part of the component is typically placed in the fluidised bed and at least one non-treatment part of the component is located substantially outside the chamber and out of contact with the fluidised bed. In this case, the boundary between the treatment part and the non-treatment part of the component is preferably defined by a boundary containment surface at a fixed location with respect to the component.

The use of a boundary containment surface in order to define the part of the component to be treated avoids the problem discussed above in relation to the locally random irregularly fluctuating shape of the surface of the fluidised bed. Furthermore, allowing the non-treatment part of the component to extend out of the treatment chamber means that large components can be treated according to preferred embodiments of the invention, without the need for a correspondingly large treatment chamber, fluidised bed and shield (for shielding the non-treatment part of the component inside the large treatment chamber).

Preferably, the apparatus is adjustable in order to adjust the position of the component with respect to the fluidised bed. For example, the depth of submersion of the treatment part may be adjustable, by suitable adjustment of the location of the component and the boundary containment surface.

Preferably, the treatment chamber has at least one side wall, in order to restrain lateral flow of the fluidised bed, the side wall thereby forming part of the boundary containment surface. Preferably, the component is disposed with respect to the treatment chamber so that the treatment part of the component is located within the treatment chamber on one side of the side wall and so that the non-treatment part of the component is located on the other side of the side wall, outside the treatment chamber. In this way, the side wall provides a definite and fixed limit to the contact between the treatment portion and the fluidised bed.

Preferably, the side wall is adapted to the shape of the component. Thus, the side wall preferably has one or more apertures corresponding in shape and location to the treatment parts of the component.

Forming multiple apertures in the side wall as discussed above allows a corresponding number of components, or multiple parts of one component, to be treated by the fluidised bed at the same time, if required.

In some embodiments, the side wall may be non-planar in order to accommodate a required non-planar boundary between the treatment parts and non-treatment parts of the component. For example, the side wall may be curved. More complex shapes, to correspond with more complex components, are of course easily envisaged and produced.

Preferably, the boundary containment surface includes at least one seal member to seal between the component and the treatment chamber (e.g. the side wall of the treatment chamber). The seal member is typically locatable in an aperture in the side wall, as mentioned above. The seal member may be shaped to complement the component shape, in order to adapt the component shape to an aperture in the side wall of the treatment chamber. In this way, one treatment chamber may be used in order to treat a series of different components of different (but typically generally similar) shapes, by providing a corresponding series of seal members. Typically, the seal member is compressible to accommodate the component. For example, a hollow seal member may be used, a hollow cavity within the seal capable of being deformed in order to fit between the side wall of the treatment chamber and the component.

Additionally or alternatively, the side wall of the treatment chamber may be replaceable, e.g. in order to adapt the treatment chamber to a more radical difference in shape between components to be treated.

Thus, in a kit of parts, the interchangeable boundary containment surfaces may be provided by a series of seal means of different shape as mentioned above and/or by a series of side walls of different shape.

In some preferred embodiments, the component may have two or more treatment parts. It is preferred, where possible, that these treatment parts are treated in the fluidised bed simultaneously. Thus, preferably the apparatus includes a corresponding plurality of boundary containment surfaces in order to define the boundary between each treatment part and the non-treatment part(s).

Where the component has two or more treatment parts, the apparatus and/or method may be adapted to allow different treatment of the treatment parts using the fluidised bed. For example, the fluidising gas flow at a first region corresponding to a first treatment part may be different to the fluidising gas flow at a second region corresponding to a second treatment part. This can be achieved by blanking off a respective part of the distributor plate of the apparatus, and/or a variation in the treatment chamber dimensions, and/or a diversionary gas stream bifurcation to regulate pressure. Additionally or alternatively, the first treatment part may have shield means applied (e.g. insulation, or deliberate stagnation to vary temperature/heat transfer coefficient as a means of insulation) different to the second treatment part.

The preferred embodiments of the invention have particular utility in the heat treatment of parts of components in order to control the mechanical properties of the components. Suitable heat treatments include controlling the temperature of the treatment part so that the treatment part has a higher or lower temperature than the non-treatment part. Additionally or alternatively, suitable heat treatments include controlling the temperature of the treatment part so that the treatment part has a higher or lower rate of change of temperature than the non-treatment part.

The solid particles may have any suitable size/shape/density distribution in order to carry out the required treatment in an efficient manner. For example, the population of solid particles may have a multi-modal size/shape/density distribution.

The fluidising gas may be independently heated.

Preferably, the fluidising gas is recycled. For example, the fluidising gas may be extracted from the treatment chamber and subjected to filtration and/or cleaning. Cleaning may be carried out by a chemical scrubbing system. The filtered/cleaned gas may then be used again as the fluidising gas.

Preferably, the apparatus includes a heat exchange system in order to extract waste heat from exhaust gas from the fluidised bed. This allows improvement of efficiency of the system.

Temperature in the process can be monitored directly, e.g. using one or more thermocouples in the bed. Additionally or alternatively, temperature may be monitored indirectly, measurement of flow of fluidising gas, power input, exit gas is temperatures, etc.

Preferably, in use, less than 50% by volume of the component is contained in the treatment part(s) of the component. Thus, preferably, the majority of the component is not located in the fluidised bed.

In the process, it is preferred that the component is initially installed in the treatment chamber before the fluidised bed is formed in the treatment chamber. In this case, the treatment part(s) of the component are preferably located above the surface of the powder bed before fluidisation. On fluidisation, the treatment part(s) of the component are then preferably completely submerged under the rising surface of the fluidised bed. This is advantageous because it allows the component to be installed in the treatment chamber without risking loss of the media.

It is possible for the component to be brought to the treatment chamber for treatment. However, for larger components, it is typically preferred for the treatment chamber to be portable, in order to treat the component in situ. Additionally or alternatively, the treatment chamber may be assembled around the treatment part of the component. In this case, typically, the media for the fluidised bed is added after assembly of the treatment chamber around the treatment part of the component. In some embodiments, it may be preferred for the treatment chamber to be provided in a clam-shell-like arrangement, in order to embrace and seal with the component in order to treat the treatment part.

Further optional features of the invention are set out below.

### BRIEF DESCRIPTION OF THE DRAWINGS

Embodiments of the invention will now be described by way of example with reference to the accompanying drawings in which:

FIG. 1 shows a schematic view of a treatment chamber for use in a treatment process according to one embodiment of the invention.

FIG. 2 shows a schematic view of the process of applying a sealing member around a turbine blade and inserting the wrapped turbine blade into an aperture in the side wall of a treatment chamber.

FIG. 3 shows a schematic sectional view of a side wall of a treatment chamber with sealing members sealing across an aperture in the side wall.

FIG. 4 shows the arrangement of FIG. 3 but with a component projecting through the side wall and sealing with the sealing members.

FIG. 5 shows an enlarged schematic sectional view of hollow sealing members suitable for use with the arrangements of FIGS. 3 and 4.

FIG. 6 shows a schematic view of an apparatus according to another, preferred, embodiment of the invention.

FIG. 7 schematically illustrates the powder transport into the treatment chamber of FIG. 6.

### DETAILED DESCRIPTION OF THE PREFERRED EMBODIMENTS, AND FURTHER OPTIONAL FEATURES OF THE INVENTION

The basic design of a fluidised bed involves a bed of solid media (usually alumina powder) situated on a distributor plate (a suitable porous or mesh-like material) located above a plenum chamber. Introduction of a process gas into the plenum chamber creates a pressure drop across the distributor plate, which in turn fluidises the media above. The holes in the distributor plate, through which the process gas flows, are typically small enough to prevent passage of the solid particles in the reverse direction through the distributor plate. Usually, fluidised beds are either rectangular or cylindrical in shape, the shape being defined by the shape of the plenum chamber and the corresponding distributor plate and also by the configuration of the side wall which contains the fluidised bed from flowing laterally out of the apparatus.

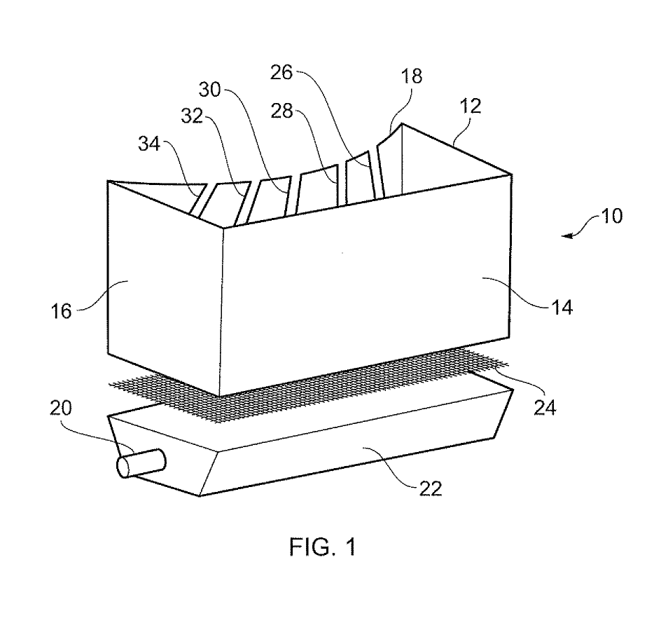

FIG. 1 shows a schematic view of a fluidised bed apparatus for use in one embodiment of the invention. The apparatus is based on a rectangular bed configuration. The apparatus has a treatment chamber 10 with four side walls. Three of the side walls 12, 14, 16 are vertical in orientation and planar in shape. The remaining side wall 18 is not planar in shape, and is described in further detail below.

The apparatus has a fluidising gas inlet 20 which delivers fluidising gas at an appropriate (and adjustable) pressure to plenum chamber 22. Interposed between plenum chamber 22 and treatment chamber 10 is distributor plate 24. Distributor plate 24 is arranged generally horizontally and is formed of a mesh sized to prevent the particulate (not shown) used as the fluidised bed media from passing from the treatment chamber into the plenum chamber.

The particulate is delivered to the treatment chamber via a powder conveyor (not shown in FIG. 1) from a powder reservoir (not shown in FIG. 1) with independent powder heating/cooling means. The powder conveyor in this embodiment delivers pre-heated but not pre-fluidised powder to the treatment chamber.

Side wall 18 of the treatment chamber attaches to side wall 12 and side wall 16. In some preferred embodiments, side wall 18 may be removably attachable to side wall 12 and side wall 16. In that case, a different side wall, typically of different shape, may be substituted for side wall 18, in order to use the apparatus to treat a different component.

Side wall 18 includes an arrangement of apertures 26, 28, 30, 32, 34. In this embodiment, each aperture takes the form of an elongate slot. In this embodiment, each aperture is open at the top of side wall 18, but in other embodiments, one or more of the apertures may not be open at the top of side wall 18. Apertures 26-34 allow treatment parts of a component (or of multiple components) to be inserted into the treatment chamber, whilst a non-treatment part of the component remains outside the treatment chamber.

The general curved shape of side wall 18 is illustrated in FIG. 1. This allows the shape of the non-treatment part of the component to be accommodated outside the treatment chamber, whilst ensuring that the treatment parts of the component are located inside the treatment chamber.

In the example illustrated in FIG. 1, the treatment chamber is adapted to treat blades, for example fan blades, compressor blades and/or gas turbine blades of a gas turbine engine.

Each aperture 26-34 is shaped in order to locate and fit with the component to be treated. Forming each aperture as an elongate slot allows the position (e.g. height) of the treatment parts of the component to be varied in the treatment chamber.

In order to reduce the likelihood of the media from the fluidised bed escaping from the treatment chamber via any gap between the component (not shown) and apertures 26-34, it is preferred to provide a seal (not shown) between the component and each aperture. The seal therefore provides a boundary containment surface in order to contain the fluidised bed with respect to the component and the side wall of the treatment chamber.

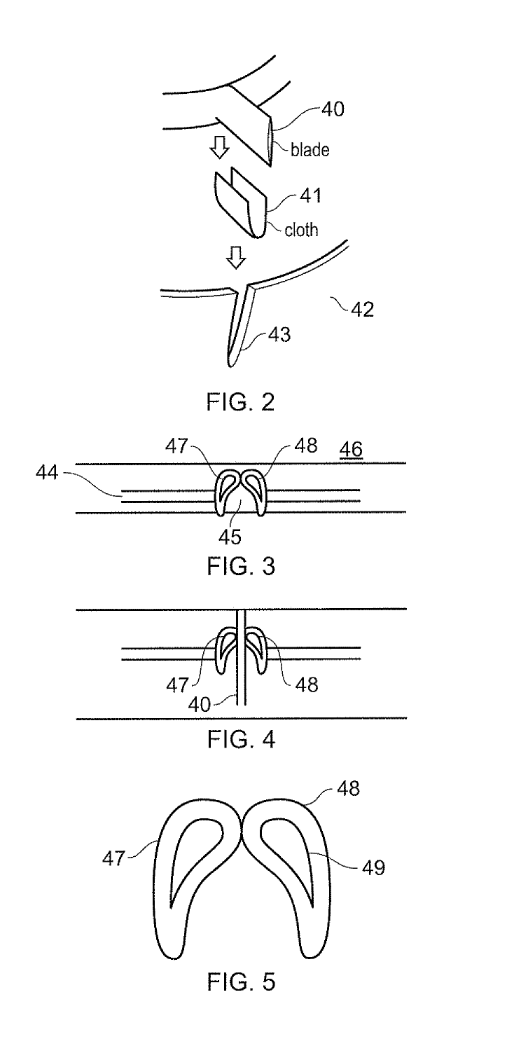

FIGS. 2-5 illustrate various sealing arrangements for providing the boundary containment surface between the component and the side wall of the treatment chamber.

In FIG. 2, a turbomachinery blade 40 is wrapped in a ceramic cloth 41 and the wrapped blade is inserted into aperture 43 in side wall 42 of a treatment chamber. Suitable ceramic cloths are known which can withstand temperatures of around 850° C. Aperture 43 can have a tapered shape, so that as the wrapped component 40 is pressed downwardly, the cloth 41 is compressed between the side wall and the component, giving sealing between the component and the side wall.

FIGS. 3 and 4 show schematic cross sectional views of a different arrangement. Side wall 44 of the treatment chamber once more has an aperture 45 formed in it. Fluidised bed powder 46 is provided internally in the treatment chamber. Opposed sealing members 47, 48 are provided at the aperture 45. In FIG. 3, the aperture 45 does not have a component projecting through it, the sealing members 47 and 48 sealing against each other. FIG. 4 shows the same arrangement as FIG. 3, but here blade 40 projects through the aperture 45 and sealing members 47, 48 seal against opposite sides of the blade 40.

FIG. 5 shows a schematic cross sectional view of sealing members 47 and 48. Each sealing member is hollow, defining an internal cavity 49. The internal cavity allows each sealing member to deform to accommodate the blade 40 and to conform with the shape of the blade 40. Additionally, the cavity allows for the flow of coolant internally along each sealing member. This is of interest in order to prevent overheating of the material of the sealing member.

In use, the treatment part of the component is inserted into the treatment chamber, through at least one of the apertures 26-34, before fluidisation of the particulate. Therefore the treatment part of the component is located above the upper surface of the non-fluidised bed of powder. The seal is located between the component and the aperture. Any non-used apertures are blanked off using suitable blanking means (not shown). The bed is then fluidised, and the fluidised surface of the bed rises to cover the entire treatment part of the component located in the treatment chamber. The boundary between the treatment part and the non-treatment part of the component is defined by the boundary containment surface, i.e. the seal between the component and the aperture.

As explained above, when a fluidised bed is fully operational, the top surface of the fluidised media is typically uneven due to a phenomenon similar to bubbling. As such, if a component is to be partially submersed into the bed, it is very difficult to control and maintain the amount of surface coverage of bed media to component. However, in the preferred embodiment described here, introducing the component at the side of the bed ensures controlled media coverage of the treatment part of the component and a well-defined boundary between the treatment part and the non-treatment part. Thus, the need for creating a level top surface of fluidised media is eliminated. Also, a more uniform temperature gradient across the component in question can be achieved. The design also allows for the component to be adjusted in height relative to the bed if required.

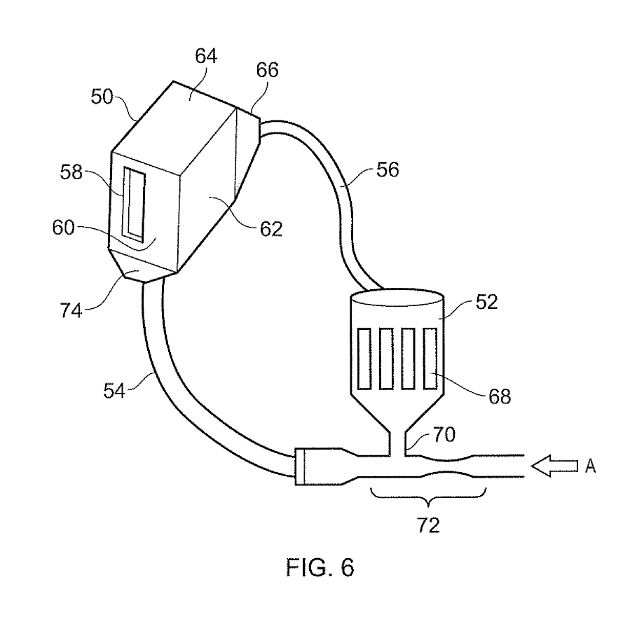

FIG. 6 shows an apparatus according to a preferred embodiment of the invention. The apparatus has a treatment chamber 50, powder reservoir 52, powder conveyor 54 and return conveyor 56.

Treatment chamber 52 differs from that shown in FIG. 1. Treatment chamber 52 has only a single aperture 58 in side wall 60. In this embodiment, side wall 60 is planar and configured in a vertical direction. However, it will be understood that side wall 60 can be shaped to fit with the component to be treated, and need not be configured in a vertical direction. Similarly, aperture 58 need not be rectangular, but may be any suitable shape to allow location of the treatment part of the component inside the treatment chamber 50, and to seal therewith.

Treatment chamber includes further sidewalls 62 and a top wall 64. The treatment chamber further includes a powder return outlet 66 for receiving used powder and gas, to be conveyed along return conveyor 56 to the powder reservoir 52.

Powder reservoir 52 is in the form of a large hopper. In this embodiment, the powder reservoir 52 is open at the top, but this would not be the case for an embodiment which uses gas recycling. Powder reservoir 52 has a height of about 1 m in this embodiment. The powder in the powder reservoir is typically not fluidised. Therefore it will be understood that the powder reservoir has a capacity for storing a relatively large mass of powder. The mass capacity of the powder reservoir is significantly greater than the mass capacity of the treatment chamber when the treatment chamber contains fluidised powder.

Conduction heaters 68 are located in powder reservoir 52 for heating the powder. Also located in the powder reservoir are temperature control thermocouples (not shown), in order to allow control of the heaters 68 to the required temperature. As the skilled person will understand, heaters 68 may be replaced by suitable coolers in order to use the principle of the invention for thermal treatment by cooling.

At the base of the powder reservoir is powder outlet 70. Powder outlet 70 gravity feeds heated powder from the reservoir to eductor arrangement 72. Eductor 72 operates in a known manner based on gas flow A moving through a constriction, into a mixing zone, and then entraining powder from the powder reservoir into the powder conveyor 54.

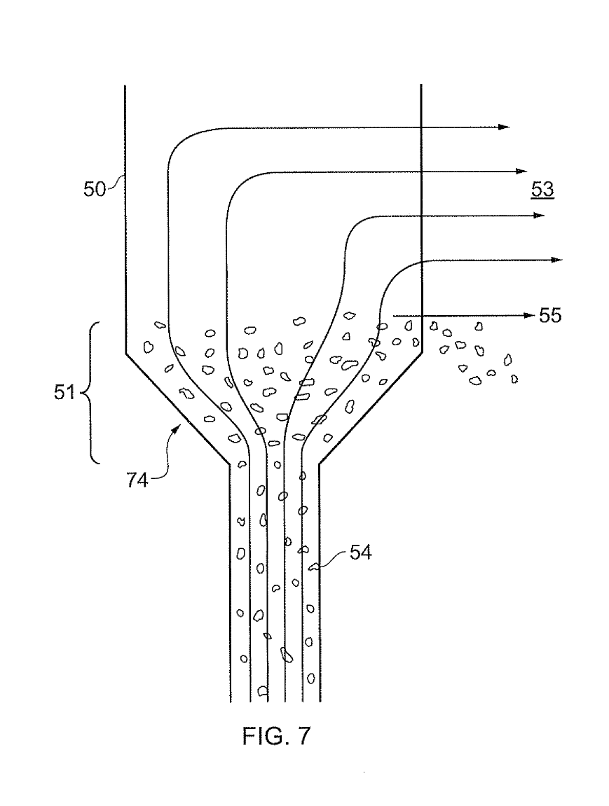

The gas with entrained powder flows to the treatment chamber 50 via plenum chamber 74. FIG. 7 shows a schematic view of powder conveyor 54 opening into plenum 74 and then into main chamber 50. In conveyor 54 there is a high gas velocity which imparts a large drag force on the powder particles, transporting them along with the gas flow. The mass flow of gas is continuous along the conveyor. In the conveyor, there is high gas velocity and low static pressure. Plenum chamber 74 takes the form of a diffuser. Here, the velocity of the gas decreases, and so the drag force on the powder particles is reduced. The result is that the powder particles are no longer transported upwardly, the local powder density increases and a fluidised bed 51 of the powder is provided. The gas continues on through the chamber 50, as shown at 53 in FIG. 7, to an outlet (not shown). As further powder arrives from conveyor 54, powder in fluidised bed 51 is forced out of the fluidised bed 51 through a slot (not shown), the flow of the powder indicated at 55 in FIG. 7.

As will be understood, in previous fluidised bed treatments, a large container of powder is fluidised and heated and the component to be treated is inserted into the bed. However, in the preferred embodiments of the present invention, the powder is heated in a separate container (and does not necessarily need to be fluidised) and is then moved to the treatment chamber to allow for heat transfer to the component.

Thus, it is possible to thermally treat components with access constraints. Such components can be locally and selectively treated. The remote treatment chamber creates a small custom/modular boundary between the treatment part of the component (e.g. blade) and the non-treatment part of the component. This allows for specific targeting of various regions of a component that would not be possible by immersion of the component into the surface of a known fluidised bed. Specific temperature distributions can be induced in a component, allowing for a predetermined localised heat treatment. Additionally, other areas of the component can be actively cooled to enhance the temperature distribution across the area of component being treated.

In the fluidised bed, the powder can be in various states of fluidisation. It can be just fluidised, at which point the powder gently bubbles. The powder can be fluidised only to the extent that it becomes stagnant when it is in contact with at least part of the component—this would then just rely on a bulk mass flow of powder to recycle powder over the component. Alternatively the powder can be extremely fluidised, where the fluid (particulate and gas) density is very low and the gas stream transporting the powder becomes more significant. In a typical fluidised bed, this state would normally cause powder to be ejected out of bed from the free surface of the bed, and so would normally not be desirable. However, in the embodiment shown in FIG. 2, the powder ejected from the bed is recovered and recycled back to the powder reservoir, and so an extreme fluidised state can be used where necessary. A high level of coverage of the component by the fluidised powder can be achieved by use of multiple inlets (not shown) within the treatment chamber. These inlets can be arranged in order to avoid uneven exposure of the component. The specific arrangement can be designed based on the shape of the treatment part of the component, typically in order to ensure that streams of fluidised media come into contact with the component in regions where fluidised media circulation is expected to be at a minimum, in view of the intrusion of the component into the treatment chamber. As will be clear, it is possible to modify the embodiment of FIG. 6 in order to have more than one treatment chamber communicating with the powder reservoir. The treatment chambers are typically arranged in parallel, in order that the temperature of the powder in each treatment chamber is substantially equal. Use of multiple treatment chambers allows the thermal treatment of more than one treatment part of the same component, or the thermal treatment of multiple components, at the same time.

Temperature control of the treatment part of the component can be achieved in a direct manner, e.g. using one or more thermocouples in the bed. Alternatively, temperature control can be indirect, through measurement of flows, power input and exit gas temperatures or a combination of the aforementioned.

The particulate may have a multi-modal size, shape or density distribution, in order to provide a desired treatment efficacy.

Air may be used as the fluidising gas. Alternatively (and preferably), other gases may be used. The fluidising gas may be recycled using a particle filter and/or a chemical scrubbing system.

As will be understood by the skilled person, it is not essential to ensure that the flow of powder in the fluidised bed is constant in all locations. Indeed, differential flow in different regions of the bed may provide advantageous effects. Thus, one or more different regions of the bed may be blanked off or made stagnant. This can be achieved using specific insulation or purposeful localised particle stagnation. Further means for achieving differential treatment can be provided by providing localised differential fluidising gas flow, e.g. by appropriate control of the gas flow in the plenum chamber. A diversionary gas stream bifurcation may be used to regulate pressure.

The shape of the treatment chambers shown in FIGS. 1, 6 and 7 is based on a rectangular shape. However, depending on the component to be treated, it is possible for the treatment chamber to be of any suitable shape. One particularly useful shape for treating components is an annular shape, in which the treatment parts of the component are inserted into the treatment chamber through either and inner annular side wall or an outer annular side wall of the treatment chamber.

The term “heat treatment” or “thermal treatment” used herein includes heating and cooling. The preferred embodiments of the invention allow any suitable fluidised bed process to be adapted by allowing a component to be treated by introduction at the side of the fluidised bed. This allows local, more uniform media flow around the treatment part of the component. The treatment may incorporate carrying out one or more chemical reactions, e.g. for chemical treatment of the component. Further applications in industry include:
Drying
Pre-heating
Surface engineering
Cooling
Combustion
Nitriding
Flame free heater for repair in a hazardous environment
Sterilisation
Shrink fitting

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. An apparatus for the treatment of a component using a fluidised bed of powder, the apparatus including:
a treatment chamber for receiving at least a treatment part of the component;
a powder reservoir having heating or cooling means for controlling the temperature of the powder; and
a powder conveying means linking the treatment chamber and the powder reservoir, for continuously conveying powder from the reservoir to the treatment chamber for use in the fluidised bed,
wherein the position of the treatment chamber is variable with respect to the powder reservoir during operation of the apparatus.

2. An apparatus according to claim 1 wherein, in the powder reservoir, the powder is in non-fluidised form.

3. An apparatus according to claim 1 wherein the powder conveying means is provided by a gas stream.

4. An apparatus according to claim 3 wherein the gas stream of the powder conveying means is used in the treatment chamber to generate the fluidised bed.

5. An apparatus according to claim 1 wherein the apparatus allows positioning of the treatment chamber with respect to the component to be treated, independently of the position of the powder reservoir.

6. An apparatus according to claim 1 wherein a return powder conveying means links the treatment chamber and the powder reservoir for transporting powder from the fluidised bed back to the powder reservoir.

7. An apparatus according to claim 6 wherein the powder is returned to the powder reservoir for renewed heating/cooling before being conveyed once more to the treatment chamber.

8. An apparatus according to claim 1 wherein the apparatus includes more than one treatment chamber, each treatment chamber being for use to treat a different treatment part of the same or different components.

9. An apparatus according to claim 1 wherein at least one treatment part of the component is placed in the fluidised bed and at least one non-treatment part of the component is located substantially outside the chamber and out of contact with the fluidised bed, the boundary between the treatment part and the non-treatment part of the component being defined by a boundary containment surface at a fixed location with respect to the component.

10. An apparatus according to claim 9 wherein the boundary containment surface includes at least one seal member to seal between the component and the treatment chamber.

11. An apparatus according to claim 1 and further including a heat exchange system in order to extract waste heat from exhaust gas from the fluidised bed.

12. A process for the treatment of a component using a fluidised bed of powder, wherein the fluidised bed is formed in a treatment chamber and in contact with at least a treatment part of the component, and wherein the powder is subjected to heating or cooling in a powder reservoir located away from the treatment chamber, the position of the treatment chamber being variable with respect to the powder reservoir during the process, the powder being continuously conveyed to the treatment chamber from the powder reservoir by a powder conveyor.

13. A process according to claim 12 wherein the fluidising gas is recycled.

14. A process according to claim 12 wherein the component is initially installed in the treatment chamber before the fluidised bed is formed in the treatment chamber, the treatment part(s) of the component being located above the surface of the powder bed before fluidisation, and on fluidisation, the treatment part(s) of the component are then completely submerged under the rising surface of the fluidised bed.

15. A kit of parts suitable for assembling an apparatus according to claim 1, wherein the kit includes two or more interchangeable treatment chambers of different shape, in order to adapt the apparatus to different shapes of specific components to be treated.
